(19) United States
(12) Patent Application Publication
(10) Pub. No.: US 2016/0203214 A1
(43) Pub. Date: Jul. 14, 2016

(54) IMAGE SEARCH RESULT NAVIGATION WITH ONTOLOGY TREE

(71) Applicant: International Business Machines Corporation, Armonk, NY (US)

(72) Inventors: Billy W. Chang, Rockville, MD (US); Sarbajit K. Rakshit, Kolkata (IN)

(21) Appl. No.: 14/884,602

(22) Filed: Oct. 15, 2015

Related U.S. Application Data
(63) Continuation of application No. 14/594,681, filed on Jan. 12, 2015.

(51) Int. Cl. G06F 17/30

(52) U.S. Cl. CPC G06F 17/30625; G06F 17/30734; G06F 17/30277

(57) ABSTRACT

Methods for navigating image search results. In response to conducting an image search based on a search query received from a user, an ontology tree is formed for each image returned as image search results. In response to receiving a request from the user, the ontology tree is displayed for an image among the images returned in the image search results. A selection of a parameter in the displayed ontology tree is received from the user. A new image search is conducted based on the selected ontology tree parameter.

### BACKGROUND

The present invention relates to search engines, and more specifically, to processing image search results. Many of today's conventional search engines that can be accessed over the Internet provide the ability to do image searches. Typically, a user submits a search query in textual form through a web based search engine user interface. In return, the user gets a search result, which typically consists of a number of images that correspond to the user's search query. Typically, smaller versions the images are arranged in some kind of grid pattern and the user can hover with a cursor above the images to obtain more information, such as the size or source of the image represented by the smaller version, or click on one of the small images to view a larger version of the image at the original location.

While these techniques may be satisfactory in many situations, there are other situations in which are not. Assume, for example, that a user who is navigating the image search results would like to view some kind of related search results. In order to do so, the user would typically have to enter a brand new search query.

For example, assume a user has entered the search term “Amazon forest” and the image search result is a large number of images including Amazon animals, birds, waterfalls, rivers, snakes, and so on. Some of the photographs may show the rainy season, others may show different times of the day, such as sunsets, early mornings, and so on. While navigating the images in the search results, the user decides what she really is interested in are images of the Animals of the Amazon. In order to do so, she must refine her search query to “Animals of the Amazon” or something similar. Having to stop reviewing search results and enter a new search may be inconvenient to some users, and thus it would be useful to have a better mechanism by which user can automatically navigate to a different selection of images compared to the ones that are provided in the initial search result.

### SUMMARY

According to the various embodiments of the present invention, techniques are provided for navigating image search results. In response to conducting an image search based on a search query received from a user, an ontology tree is formed for each image returned as image search results. In response to receiving a request from the user, the ontology tree is displayed for an image among the images returned in the image search results. A selection of a parameter in the displayed ontology tree is received from the user. A new image search is conducted based on the selected ontology tree parameter.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows a process for creating a content repository of searchable images, in accordance with one embodiment of the invention.

FIG. 2 shows a process for performing an image search in accordance with one embodiment of the invention.

FIG. 3 shows how hovering a cursor over any image among the search results displays an ontology tree for optional refinement of the search, in accordance with one embodiment of the invention.

FIG. 4 shows an ontology tree in accordance with one embodiment of the invention.

Like reference symbols in the various drawings indicate like elements.

### DETAILED DESCRIPTION

The various embodiments of the invention described herein pertain to techniques that allow a user to hover a cursor over any image in a set of search results, in order to view an ontology tree for the image. The user may then refine the search criteria by clicking on an item in the ontology tree and view only images that correspond to the selected item. The ontology tree can either be created by the user (e.g., <Location> >> <Timing> >> <Semantic Context of Image> >> <Primary Object>, etc.), or alternatively the ontology tree can be provided by a service provider (which may or may not be the same service provider that provides the search results) so that the ontology can be changed based on the type of search query. In some embodiments, the user can also share her own created ontology tree with, for example, friends in a social network to give them access to the ontology tree.

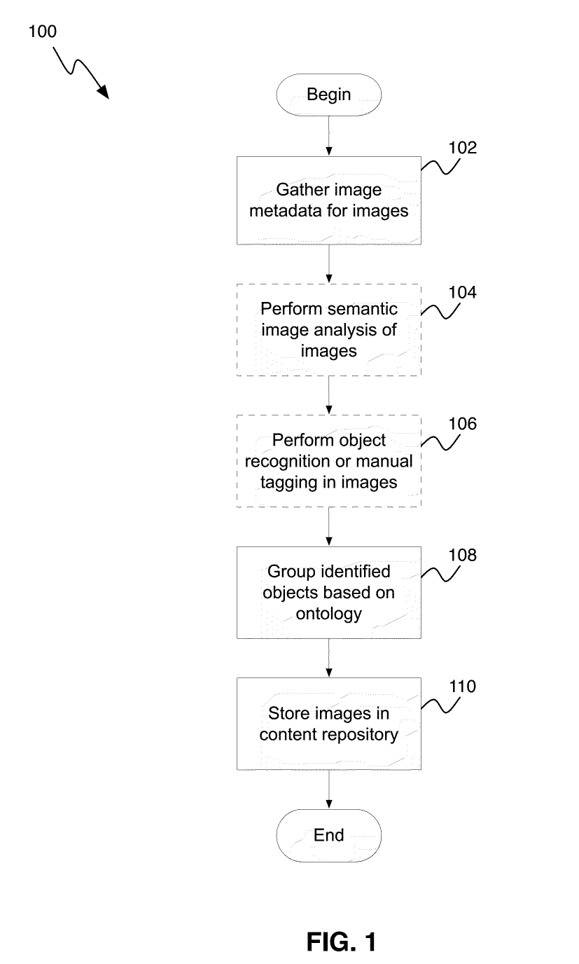

Referring to FIG. 1, a process (100) for creating a content repository of searchable images, in accordance with one embodiment of the invention is shown. As can be seen in FIG. 1, the process (100) starts by gathering metadata of images, such as the location of capture, the time of capture, the date of capture, and so on (step 102).

Next, optionally, semantic analysis of image is performed (optional step 104). Semantic analysis of images is well known to those of ordinary skill in the art. The results of the semantic analysis are added as additional metadata for the image.

After performing semantic analysis, optionally, automatic object recognition and/or manual tagging is performed to identify individual objects within the image (optional step 106). Object recognition techniques and manual tagging techniques are also well known to those of ordinary skill in the art. The identified objects are also added to the image as additional metadata. It should be noted that while step 106 is optional, it significantly aids in enhancing the metadata for an image such that a proper ontology tree can be displayed, as will be described below.

Finally, the images are grouped based on ontology (step 108) and stored in a content repository (step 110) (e.g., a database) where they can be accessed by the search engine. This concludes process (100).

It should be noted that the concept of metadata, as used herein, can include a wide variety of information and be organized in a number of ways. For example, some users may choose to categorize metadata such as “location” (e.g., in geolocation coordinates), “time of day,” “season and weather condition,” “object type” (e.g., animal or plant), “object name” (e.g., bear or orchard), etc. Other users may choose to use a simple list of keywords as metadata (e.g., forest, animal foot prints, trees), etc.

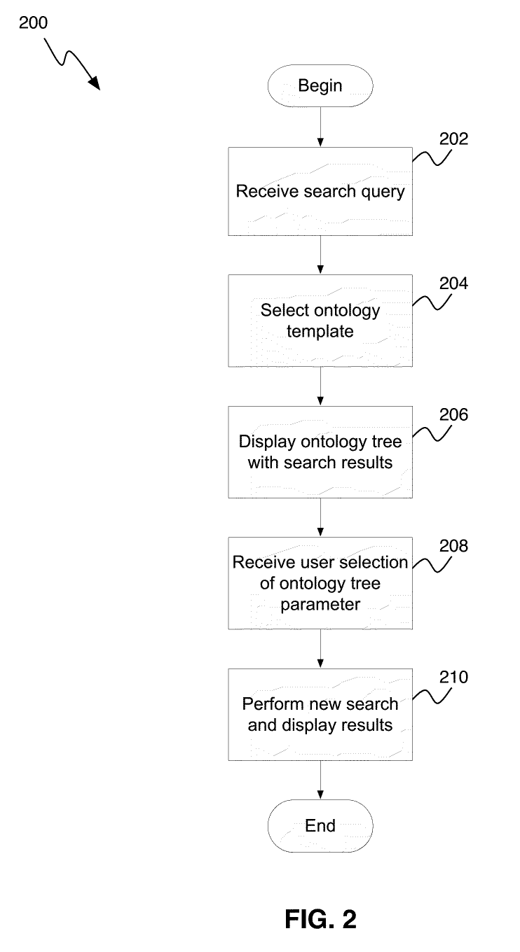

FIG. 2 shows a process (200) for performing an image search in accordance with one embodiment of the invention. It is assumed at the beginning of the process that the user has already configured the search engine with one or more ontology tree templates, or that the search engine already has a set of pre-configured templates. The purpose of the ontology tree templates is to provide a structure for the best fit and order in which the metadata associated with the images can be displayed in the ontology tree.

As can be seen in FIG. 2, the process (200) starts by receiving a search query (step 202). Based on the search query, an appropriate ontology tree template is selected (step 204). Several criteria can be used in selecting the appropriate template. Some examples include:

the list of common fields found from the list of search results

the list of keywords found from the list of search results

the nature of the majority of the list of search results (i.e., are they mostly images of a certain category).

While there can be many methods for template selection, there are several ways this can be implement to achieve optimal clarity. In one embodiment a list of criteria (like the above one) is used as a hunt list of rules (if first rule identifies a template then use it, if exact template found, try next rule). In another embodiment, a list of criteria (like the above one) is used and a score is generated for each list (e.g., criteria one score=the number of common fields found). The score is then normalized for each criterion and then the scores are added up for each template. The templates are then ranked and the highest-scoring template is the template of choice. In yet another embodiment, a user can preselect a specific template that has the key categories of interest. For example, user A may only be interested in Location ->Animal, but does not care about “Time of Day” or “Season/Weather.” It should be noted that these are merely a few exemplary embodiments and that many other ways for selecting appropriate ontology tree templates can be envisioned by those having ordinary skill in the art.

Next, the selected ontology tree is displayed along with the search results (step 206). In one embodiment, the ontology tree is displayed when the user hovers the cursor over an image search result.

Next a user selection of a parameter in the ontology tree is received (step 208). Based on the selected parameter, a new search is performed for the selected category (step 210) and the results are displayed to the user, either on the same page or on a different page in the web browser, which completes process (200).

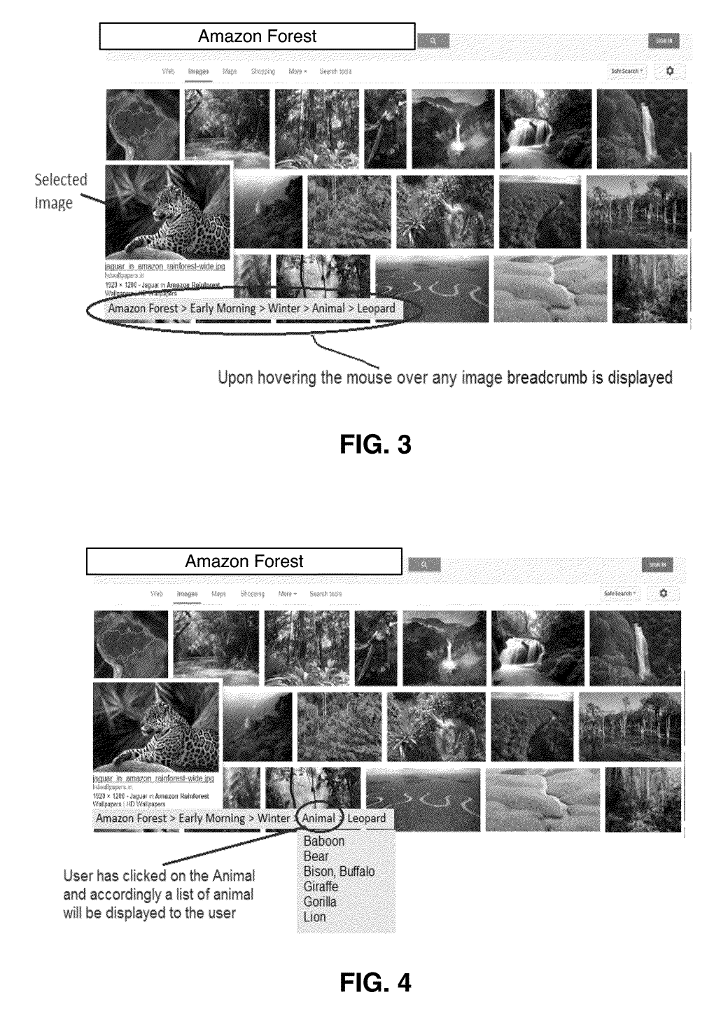

FIG. 3 shows how hovering a cursor over any image among the search results displays an ontology tree for optional refinement of the search.

FIG. 4 shows further details on an exemplary ontology tree. In FIG. 4, the user has selected “Animal,” and accordingly a list of animals is displayed. From this list, the user can select any animal. For example, if the user selects “Bear”, then the revised search ontology tree will be:

Amazon Forest > Early Morning > Winter > Animal > Bear

Similarly, the user can change other parameter values in the ontology tree. For example, changing “Winter” to “Rainy” in the above ontology tree would result in the following ontology tree:

Amazon Forest > Early Morning > Rainy > Animal > Bear

As was described above, based on these changes, the search query will be refined and the new results will be displayed to the user in the same window or in a different window.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for navigating image search results, comprising:
in response to conducting an image search based on a search query received from a user, forming an ontology tree for each image returned as image search results;
in response to receiving a request from the user, displaying the ontology tree for an image among the images returned in the image search results;
receiving a selection from the user of a parameter in the displayed ontology tree; and
conducting a new image search based on the selected ontology tree parameter.

2. The method of claim 1, wherein forming the ontology tree includes:
selecting an ontology tree among one or more pre-configured ontology tree templates, based on the received search query.

3. The method of claim 1, wherein the parameters of the ontology tree are derived from metadata associated with the images.

4. The method of claim 1, further comprising:
performing semantic analysis of one or more images to derive metadata for each of the one or more images.

5. The method of claim 1, further comprising:
performing object recognition to derive metadata for each of the one or more images.

6. The method of claim 1, further comprising:
identifying one or more objects in the images and grouping the identified objects based on ontology.

7. The method of claim 1, wherein displaying the ontology tree includes:
displaying the ontology tree in response to a user hovering a cursor over an image among the images in the search result.

8. The method of claim 1, further comprising:
modifying a parameter in the ontology tree; and
conducting a new image search based on the modified ontology tree parameter.

9. The method of claim 1, wherein the ontology tree is a personalized ontology tree created by a user.

10. The method of claim 1, further comprising:
sharing the ontology tree with other users in a social network.
